(19) United States
(12) Patent Application Publication
(10) Pub. No.: US 2016/0236418 A1
(43) Pub. Date: Aug. 18, 2016

(54) ERROR PATTERN COMPENSATION

(71) Applicants: Michael Daniel Armani, Bethesda, MD (US); David Souza Jones, Burtonsville, MD (US)

(72) Inventors: Michael Daniel Armani, Bethesda, MD (US); David Souza Jones, Burtonsville, MD (US)

(21) Appl. No.: 14/841,603

(22) Filed: Aug. 31, 2015

Related U.S. Application Data
(60) Provisional application No. 62/117,439, filed on Feb. 17, 2015.

(51) Int. Cl. B29C 67/00; G05B 19/402

(52) U.S. Cl. CPC B29C 67/0088; G05B 19/402; B33Y 50/02

(57) ABSTRACT

An accelerometer is supported on a print head assembly to determine actual acceleration, and a computer system is used to obtain and store information about error in movement along a specified axis. The method used is to activate a motor for a selected axis at a particular location, then calculate an expected acceleration. The next step is to measure the actual acceleration data and then compute error data. Following that is a step to store error data in the memory as a function of position and error. These steps are repeated for N locations along each specified axis. Then, this error data is referred to during actual printing operations to reduce error.

### CROSS REFERENCE TO RELATED APPLICATIONS

This application claims the priority of Provisional Application No. 62/117,439 filed on Feb. 17, 2015, inventors Michael Daniel Armani and David Souza Jones, entitled “3D Printer”. The entire disclosure of this provisional patent application is hereby incorporated by reference thereto, in its entirety.

### STATEMENT REGARDING FEDERALLY SPONSORED RESEARCH OR DEVELOPMENT

Not applicable.

### FIELD OF THE INVENTION

The present invention relates to error pattern compensation in printing operations, and specifically for use in a 3D printer.

### BACKGROUND OF THE INVENTION

It is a problem in the art to improve printer accuracy, and in particular it is a problem to improve printer accuracy in 3D printing operations.

### SUMMARY OF THE INVENTION

From the foregoing, it is seen that it is a problem in the art to provide a device meeting the above requirements. According to the present invention, a device is provided which meets the aforementioned requirements and needs in the prior art. Specifically, the device according to the present invention provides a device to improve printer accuracy, and in particular it is a problem to improve printer accuracy in 3D printing operations.

The device of the present invention provides an error pattern compensation apparatus and method to improve printer accuracy, and in particular to improve printer accuracy in 3D printing operations.

Other objects and advantages of the present invention will be more readily apparent from the following detailed description when read in conjunction with the accompanying drawings.

### BRIEF DESCRIPTION OF THE DRAWINGS

FIG. 1 is a schematic front elevational view of a print head assembly supporting an accelerometer, according to the present invention.

FIG. 2 is a schematic view of a computer system interacting with motors and with the accelerometer of FIG. 1, according to the present invention.

FIG. 3 is a flowchart schematically depicting steps used in the performance of the present invention.

FIG. 4 is a schematic diagram showing wobble and wobble compensation.

### DETAILED DESCRIPTION OF THE INVENTION

FIG. 1 is a schematic front elevational view of a print head assembly 50 supporting an accelerometer 52, according to the present invention. The print head assembly has a nozzle 54. The accelerometer 62 senses movement in the X, Y, and Z directions. When the print head assembly is stationary there is no acceleration; when movement occurs from a stationary position then there is acceleration in at least one direction.

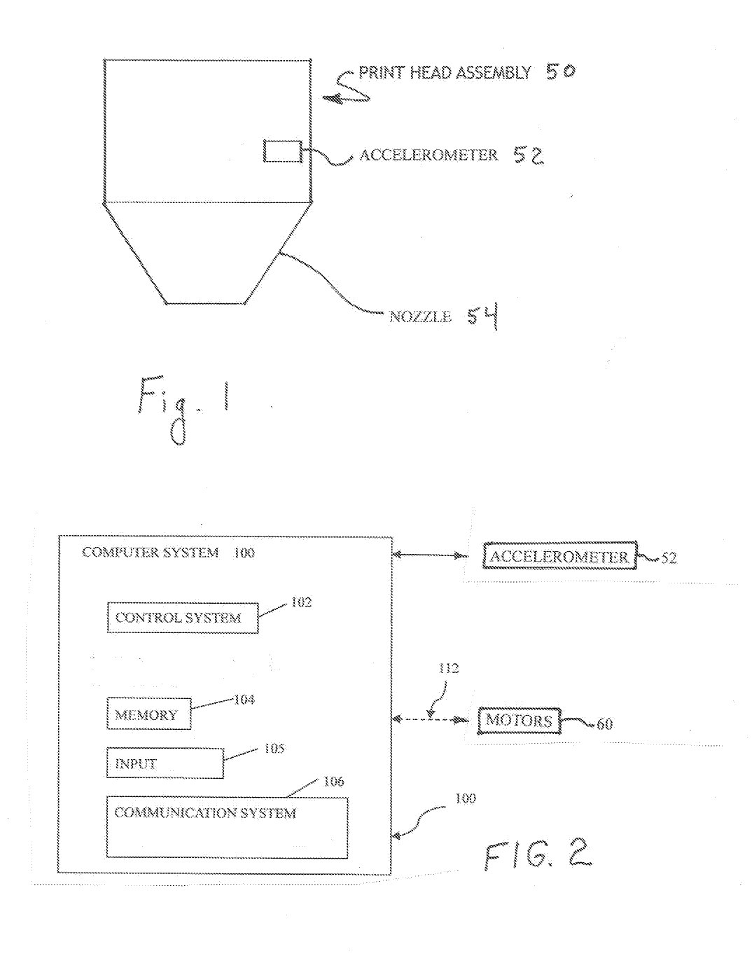

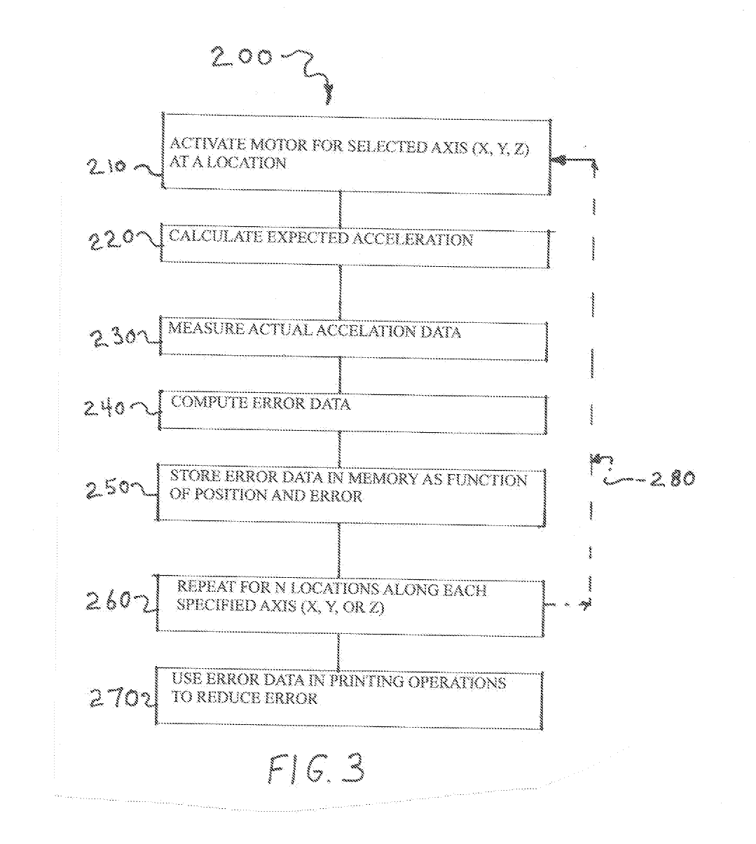

FIG. 2 is a schematic view of a computer system 100 interacting with motors 60 and with the accelerometer 52 of FIG. 1. Communication with the motors is indicated by the line 112. The computer system 100 includes a control system 102, a memory 104, an input means 105 for receiving any of a variety of types of inputs, and a communication system 106 for communicating with external devices and/or systems. The computer system 100 can be in the form of a microprocessor and elements on a microprocessor board.

As a CNC machine or 3D printer moves, it may wobble or have positioning errors. The positioning errors are systematic and reproducible based on the position of each axis (X, Y, and Z). By using the accelerometer 52 on the moving tool (print head assembly) 50 of the printer or CNC, one can measure movement errors. The error is measured by moving in one axis only and measuring acceleration using the accelerometer 52. The movement errors can be calculated from the acceleration data by subtracting the expected acceleration from the recorded acceleration. If the axis moves in only one direction at a time, the other axes are not supposed to move and it is easy to detect errors in those axes using the recorded accelerations in those directions. By measuring these accelerations as the machine moves along an axis, one can then compensate in the future for the position errors.

For example, one may know that as the 3D printer is moved along the X axis, it could wobble in the Y axis. One may then measure a Y axis movement (i.e., wobble) sinusoidal movement of 0.1 mm every 30 mm of movement along the X axis, for example. The computer system 100 includes calibration software that creates a function of position and error.

Then, when actually using the system to move the print head assembly (tool) 50 for 3D printing, the computer system adds compensation for the calculated error. This results in much more accurate positioning despite systematic errors which may change over long term use of the machine. Therefore these errors can be calibrated for and compensated for automatically even after thousands of hours of use, maintaining high precision despite an otherwise low precision system.

The amplitude of the acceleration changes that are recorded from the accelerometer can be used to estimate the actual distance errors based on previously recorded accelerometer readings. The data from the accelerometer is noisy but one can assume a certain pattern to the error, such as a sinusoidal pattern and then use the data to estimate the real pattern.

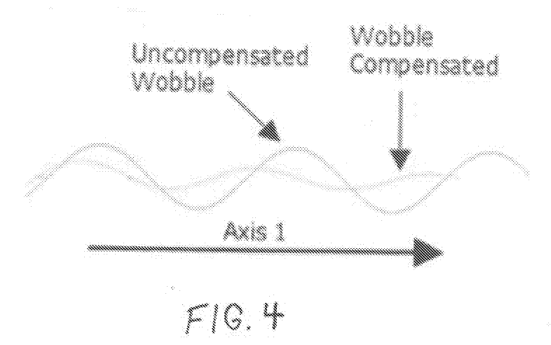

FIG. 3 is a flowchart 200 schematically depicting steps used in the performance of the present invention. Step 210 is to activate the motor for a selected axis (X, Y, Z) at a particular location. Step 220 is to calculate an expected acceleration. Step 230 is to measure the actual acceleration data. Step 240 is to compute error data. Step 250 is to store error data in the memory 104 as a function of position and error. Step 260 is to repeat the above steps for N locations along each specified axis (X, Y, or Z). Step 270 is to use the error data in printing operations to reduce error.

FIG. 4 is a schematic diagram showing a curve depicting uncompensated wobble and a curve depicting wobble following wobble compensation.

The invention being thus described, it will be evident that the same may be varied in many ways by a routineer in the applicable arts. Such variations are not to be regarded as a departure from the spirit and scope of the invention and all such modifications are intended to be included within the scope of the claims.

What is claimed is:

1. An error pattern compensation apparatus for using in printing, comprising:
a print head assembly;
at least one motor for moving said print head assembly along a specified axis;
an accelerometer carried by said print head assembly to determine actual acceleration; and
a computer system to obtain and store information about error in movement along said specified axis.

2. An error compensation method for use in printing, comprising the steps of:
providing a print head assembly;
providing at least one motor for moving said print head assembly along a specified axis;
providing an accelerometer carried by said print head assembly to determine actual acceleration;
providing a computer system to obtain and store information about error in movement along said specified axis;
activating a motor for a selected axis at a particular location,
calculating an expected acceleration,
measuring actual acceleration data,
computing error data, and
storing the error data in the memory as a function of position and error.
